(19) United States
(12) Patent Application Publication
(10) Pub. No.: US 2026/0030037 A1
(43) Pub. Date: Jan. 29, 2026

(54) HARDWARE-MANAGED ADAPTIVE WAKEUP OF PROCESSING SYSTEMS

(71) Applicant: TEXAS INSTRUMENTS INCORPORATED, Dallas, TX (US)

(72) Inventors: Anand Kumar G, Bangalore (IN); Veeramanikandan Raju, Bangalore (IN)

(21) Appl. No.: 18/784,097

(22) Filed: Jul. 25, 2024

(51) Int. Cl. G06F 9/4401

(52) U.S. Cl. CPC G06F 9/4418

(57) ABSTRACT

Various embodiments disclosed herein relate to adaptive wake-up of elements of a processing system, and more specifically, to generating early wake signals prior to interrupt signals to perform wake-up operations ahead of triggering interrupt service routines based on the interrupt signals. In an example embodiment, a system includes a standby mode control circuit and a first interrupt generation circuit coupled to the standby mode control circuit. The standby mode control circuit is configured to receive an indication of a standby mode and determine an early wake value based on the standby mode. The first interrupt generation circuit is configured to receive the early wake value, determine a first lead time value based on the early wake value, generate a first early wake signal corresponding to the standby mode based on the first lead time value, and subsequent to generating the early wake signal, generate an interrupt signal.

### TECHNICAL FIELD

This relates generally to embedded systems and low-power mode operations thereof.

### BACKGROUND

In embedded systems, power circuitry and clock circuitry may be included to drive operations of elements of the embedded systems by supplying the elements with supply power and clock signals, respectively. Such circuitry may be configured to provide supply power at varying voltage levels and clock signals with varying clock frequency to enable the elements of an embedded system to operate in different power modes, such as low-power modes or active, operational power modes. In the active mode, the elements of the embedded system may perform run-time operations with a higher processing capacity relative to a low-power mode, and while in the low-power mode, the elements of the embedded system may perform fewer operations or may operate at reduced speeds to reduce power consumption.

When operating in low-power modes, the clock circuitry may provide fewer clock signals or may provide a clock signal with a low frequency, and the power circuitry may reduce the supply power provided to various elements of the embedded system. To transition from a low-power mode, the clock circuitry may ramp up the clock signal to a higher frequency, and the power circuitry may increase the voltage supplied to the various elements. However, delay introduced when transitioning from a low-power mode to an active mode may introduce issues and processing latency.

In existing solutions, an embedded system may include a processor capable of executing software at pre-determined intervals to transition from a low-power mode to an active mode. However, such solutions lack flexibility to transition between power modes based on variable throughput of elements of the embedded system, such as peripheral devices that may asynchronously output interrupt signals requiring operation in the active mode. In other existing solutions, an embedded solution may operate in low-power modes similar to the active mode, such that the transition from the low-power mode to the active mode may occur quickly. However, such solutions fail to conserve as much energy as solutions that operate in deep low-power modes as such solutions sacrifice power conservation for reduced latency.

### SUMMARY

Disclosed herein are improvements to standby mode and active mode control of a processing system, and more particularly, to adaptively exiting a standby mode at a time ahead of an interrupt to prepare the processing system to enter the active mode and perform an interrupt servicing routine. In an example embodiment, a system includes a standby mode control circuit and a first interrupt generation circuit coupled to the standby mode control circuit. The standby mode control circuit is configured to receive an indication of a standby mode and determine an early wake value based on the standby mode. The first interrupt generation circuit is configured to receive the early wake value, determine a first lead time value based on the early wake value, generate a first early wake signal corresponding to the standby mode based on the first lead time value, and subsequent to generating the early wake signal, generate an interrupt signal.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system configurable to perform adaptive mode switching processes in an implementation.

FIG. 2 illustrates example timing diagrams with respect to transitioning between power modes of a processing system in an implementation.

FIGS. 3A and 3B illustrates a series of steps for generating early wake signals to adaptively transition out of a standby mode during operation of a processing system in an implementation.

FIG. 4 illustrates a sequence diagram for adaptively transitioning between power modes of a processing system in an implementation.

FIG. 5 illustrates an example system configurable to perform adaptive wake-up processes in an implementation.

FIG. 6 illustrates an example interrupt generation circuit in an implementation.

FIG. 7 illustrates an example aspect of an interrupt generation circuit in accordance with an implementation.

FIG. 8 illustrates an example interrupt generation circuit in an implementation.

FIG. 9 illustrates an example interrupt generation circuit in an implementation.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Embodiments of the present disclosure will be described in specific contexts, such as in processing systems with respect to interrupt servicing routines and transitioning between different power modes for performing interrupt servicing routines. Some embodiments may be used in applications that require a processor or processor core (e.g., a central processing unit (CPU)) to perform the interrupt servicing routines, e.g., as indicated by an interrupt signal, in precise time, such as motor control applications, waveform generation applications (e.g., signal conversion applications to empty and/or refill a memory buffer), sensing applications (e.g., wireless human implant applications), and acknowledgement and negative acknowledgement (NACK) generation application in communication environments. Some embodiments may, for example, be associated with peripheral devices having a buffer memory device (e.g., a first-in first-out buffer) requiring filling or emptying of contents of the buffer memory device.

Discussed herein are enhanced components, techniques, and systems related to power mode control of a processing system, and more particularly, to adaptively exiting a low-power mode (e.g., a standby mode) at a time prior to an interrupt to prepare the processing system to enter an active mode and perform an interrupt servicing routine based on the interrupt. In a processing system, an interrupt servicing circuit (e.g., a processor core, e.g., a central processing unit (CPU)) may be included to perform interrupt service routines, among other operations, based on an interrupt signal from an interrupt generation circuit (e.g., a peripheral device, e.g., an analog-to-digital converter (ADC)). The interrupt servicing circuit may operate in different power modes, such as an active power mode or a low power mode, based on a number of ongoing processes. The interrupt servicing circuit may enter a power mode based on power signals and clock signals supplied to the interrupt servicing circuit by power management circuitry, which may include a clock generation circuit and a power management unit (PMU) in some embodiments. In the active mode, the interrupt servicing circuit may consume more power and operate using higher frequency clock signals, relative to operating in the standby mode, and may perform various operations, such as interrupt service routines. In the standby mode, the interrupt servicing circuit might stay idled, and thus, might not be operational and able to perform tasks such as interrupt service routines.

In existing solutions, the interrupt servicing circuit may transition from a standby mode to the active mode based on receiving an interrupt signal or based on a pre-determined wake-up schedule. In the former example solution, the interrupt servicing circuit may wake up (e.g., exit the standby mode and enter the active mode) after receiving an interrupt from an interrupt generation circuit, e.g., when the interrupt generation circuit requires performance of an interrupt service routine. However, this may introduce latency in the processing system as there is a delay between the time the interrupt generation circuit outputs the interrupt signal and the time the interrupt servicing circuit actually exits from the standby mode and becomes ready to perform the interrupt service routing. In the latter example solution, the interrupt servicing circuit may be woken up based on a pre-determined, or software-defined, schedule. However, this may create issues in the processing system if the interrupt generation circuit outputs the interrupt signal asynchronously with respect to the schedule. In some other example solutions, the interrupt servicing circuit may operate in higher throughput standby modes relative to other low-power modes, such that there is less latency when transitioning to the active mode. However, this solution consumes more power than other solutions as the interrupt servicing circuit might not enter into deep standby modes to conserve as much power as possible as the deep standby modes.

Instead, as discussed herein, a system may include mode control circuitry and interrupt generation circuitry coupled to the mode control circuitry to adaptively transition between power modes at times prior to receiving interrupt signals from the interrupt generation circuitry. For example, the mode control circuitry can provide a value to the interrupt generation circuitry corresponding to a standby mode, and the interrupt generation circuitry can generate and output an early wake signal based on the value. Based on receiving the early wake signal, and prior to the interrupt generation circuitry outputting an interrupt signal, the mode control circuitry can initiate a transition of an interrupt serving circuit from the standby mode to an active mode, such that the interrupt servicing circuit of the system can become ready when the interrupt generation circuitry outputs the interrupt signal and perform an interrupt service routine operation without latency. Advantageously, such a system can reduce latency and delay between receiving interrupt signals and performing respective interrupt service routines such that interrupt service routines can be executed in a precise manner with respect to time as the mode control circuitry can transition the interrupt servicing circuit from a standby mode to the active mode at adaptive and dynamic times. The timing precision and reduced latency of interrupt route servicing are important to applications, especially those requiring high frequency control and fast data processing.

In an example embodiment, a system includes a standby mode control circuit and a first interrupt generation circuit coupled to the standby mode control circuit. The standby mode control circuit is configured to receive an indication of a standby mode and determine an early wake value based on the standby mode. The first interrupt generation circuit is configured to receive the early wake value, determine a first lead time value based on the early wake value, generate a first early wake signal corresponding to the standby mode based on the first lead time value, and subsequent to generating the early wake signal, generate an interrupt signal.

In another example embodiment, a device including a power control circuit and a mode control circuit coupled to the power control circuit is provided. The power control circuit is configured to receive an indication of a standby mode and control power management circuitry based on the standby mode. The mode control circuit is configured to determine an early wake value based on the standby mode, output the early wake value, in response to outputting the early wake value, receive an early wake signal corresponding to the standby mode based on the early wake value, and control the power control circuit based on the early wake signal.

In yet another example embodiment, a system including a first circuit and a second circuit is provided. The first circuit is configured to receive an early wake value corresponding to a standby mode, determine a lead time value based on the early wake value, and generate an early wake signal corresponding to the standby mode based on the lead time value. The second circuit is configured to, subsequent to the first circuit generating the early wake signal, generate an interrupt signal.

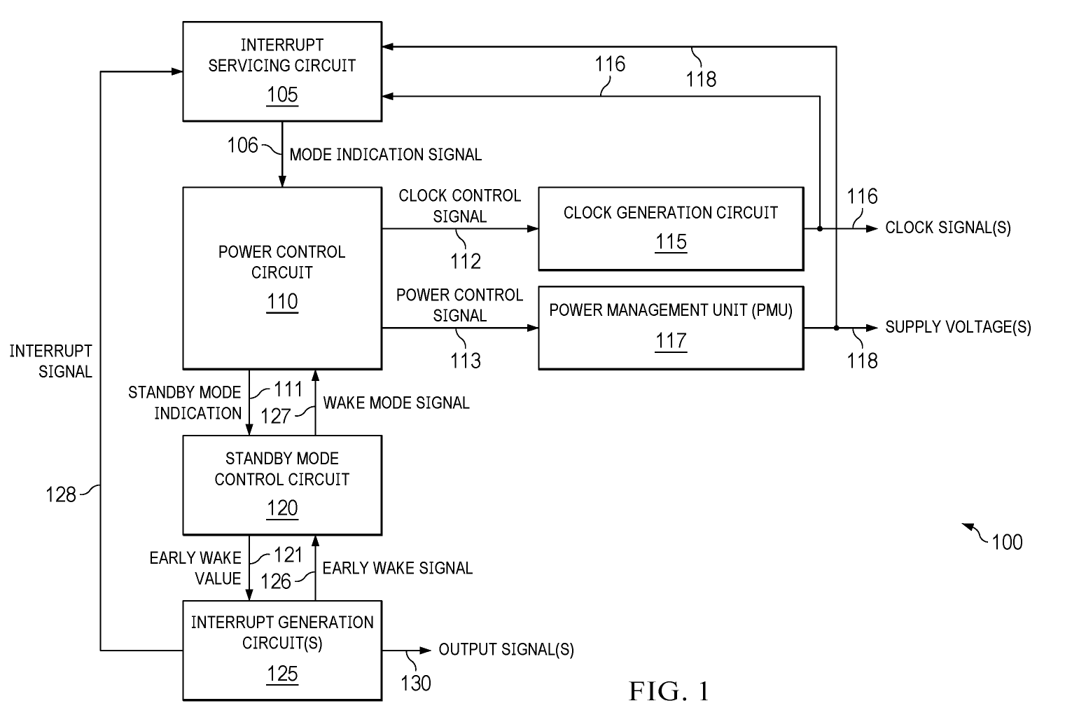

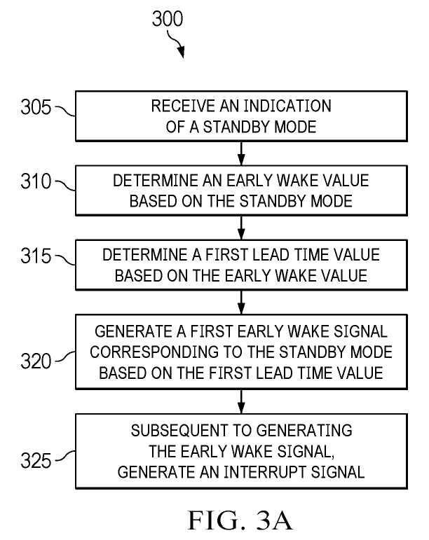

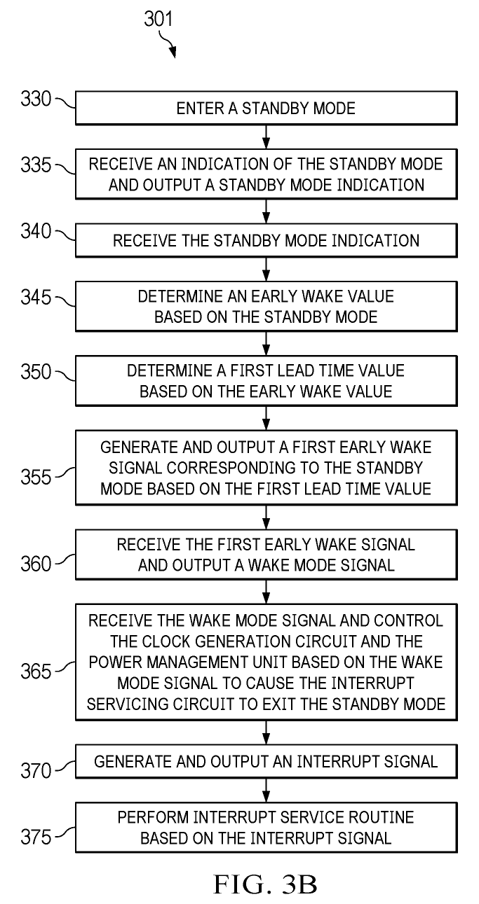

FIG. 1 illustrates an example system configurable to perform adaptive mode switching processes in an implementation. FIG. 1 shows system 100, which includes interrupt servicing circuit 105, power control circuit 110, clock generation circuit 115, power management unit (PMU) 117, standby mode control circuit 120, and interrupt generation circuit(s) 125. Elements of system 100 may be configured to enable different modes of operations, perform various functions in respective modes, and enable transitions between the different modes, such as illustrated in methods 300 and 301 of FIGS. 3A and 3B, respectively.

In various embodiments, system 100 may be representative of a processing system capable of operating in multiple power modes and performing interrupt service routine (ISR) operations in an active mode of the power modes. Elements of system 100 may include dedicated, fixed-purpose hardware components capable of performing power mode transition operations, such as operations of methods 300 and 301 of FIGS. 3A and 3B, respectively. System 100 may be embodied in circuitry utilized in one or more embedded systems, an integrated circuit, a field-programmable gate array, and/or a system-on-chip (SoC), such as a microcontroller unit (MCU). In some embodiments, elements of system 100 may be located onboard one or more integrated circuits. In some such embodiments, some elements of system 100 may be off-chip relative to other elements of the system onboard an integrated circuit. For example, interrupt generation circuit 105 may be implemented on one integrated circuit device, while the other elements of system 100 may be implemented on one or more separate integrated circuit devices. Alternatively, the entire system 100 may be implemented on one single integrated circuit device.

Interrupt servicing circuit 105 may be configured to receive clock signal(s) 116 and supply voltage(s) 118 from clock generation circuit 115 and PMU 117, respectively, and operate in a mode based on clock signal(s) 116 and supply voltage(s) 118. In various embodiments, interrupt servicing circuit 105 may be representative of one or more processing devices, circuits, cores, or systems capable of executing program instructions and enabling functionality of system 100 based on executing the program instructions. Examples of interrupt servicing circuit 105 may include one or more general purpose processors, central processing units (CPUs), digital signal processors (DSPs), application-specific integrated circuits (ASICs), field-programmable logic arrays (FPGAs), and the like.

Based on receiving clock signals 116 and supply voltages 118, interrupt servicing circuit 105 may be configured to operate in a mode, such as an active mode or a low power mode (e.g., a standby mode). Interrupt servicing circuit 105 may output mode indication signal 106 that indicates the operating mode of interrupt circuit 105 to power control circuit 110.

Power control circuit 110 may be representative of one or more circuits capable of controlling clock generation circuit 115 and PMU 117, which in turn controls the mode of interrupt servicing circuit 105. In some embodiments, power control circuit 110 may operate based on signals provided by interrupt servicing circuit 105 (e.g., mode indication signal 106) and by standby mode control circuit 120 (e.g., wake mode signal 127). Power control circuit 110 may be coupled to interrupt servicing circuit 105 to receive mode indication signal 106 and may further be coupled to clock generation circuit 115, PMU 117, and to standby mode control circuit 120. Power control circuit 110 may receive mode indication signal 106, determine whether mode indication signal 106 indicates a standby mode, and based on determining that mode indication signal 106 includes an indication of a standby mode, power control circuit 110 can output standby mode indication 111 to standby mode control circuit 120.

Based on mode indication signal 106, power control circuit 110 can control clock generation circuit 115 and PMU 117 to produce clock signals 116 and supply voltages 118 accordingly via clock control signal 112 and power control signal 113, respectively, which may cause interrupt servicing circuit 105 to enter a corresponding operational mode. In various embodiments, clock control signal 112 may include an indication of a subset of clock signals, and/or clock frequencies thereof, for clock generation circuit 115 to enable. Similarly, power control signal 113 may include an indication of a subset of supply voltages (e.g., supply rails), and/or voltages thereof, for PMU 117 to enable. Based on clock signals 116 and supply voltages 118, power control circuit 110 may cause interrupt servicing circuit 105 to enter into multiple different types of standby modes, including a standby fast mode and a standby slow mode, as well as an active mode. For example, when mode indication signal 106 includes an indication of the standby mode, power control circuit 110 may control clock generation circuit 115 and PMU 117 to lower a frequency of clock signals 116 and a voltage level of supply voltages 118, such that interrupt servicing circuit 105 may enter the standby mode (e.g., to save energy). Conversely, when mode indication signal 106 includes an indication of the active mode, power control circuit 110 may control clock generation circuit 115 and PMU 117 to increase the frequency of clock signals 116 and the voltage level of supply voltages 118, such that interrupt servicing circuit 105 may exit the standby mode to enter the active mode (e.g., to become ready to perform an interrupt service routine).

The different types of standby modes may correspond to different levels of idling in which interrupt servicing circuit 105 may have different levels of power consumption. For example, the standby fast mode may refer a standby mode in which power control circuit 110 controls clock generation circuit 115 to enable and output a first subset of clock signals and in which power control circuit 110 controls PMU 117 to enable and output a first subset of supply voltages. The standby slow mode may refer a standby mode in which power control circuit 110 controls clock generation circuit 115 to enable and output a second subset of clock signals and in which power control circuit 110 controls PMU 117 to enable and output a second subset of supply voltages. The second subset of clock signals may include a fewer number of clock signals or may include one or more clock signals having a lower frequency relative to clock signals of the first subset of clock signals, and the second subset of supply voltages may include a fewer number of supply voltages or may include one or more supply voltages of a lower voltage relative to the supply voltages of the first subset of supply voltages. It follows that, in the standby slow mode, system 100 may consume less power than in the standby fast mode based on the clock signals, frequencies thereof, and the supply voltages used in respective modes. Further, it may take a longer time for interrupt servicing circuit 115 to exit the standby slow mode than the standby fast mode. In the active mode, power control circuit 110 may control clock generation circuit 115 and PMU 117 to output normal and relatively higher frequency clock signals and supply voltages, respectively, to enable run-time operations of interrupt servicing circuit 105.

Standby mode control circuit 120 may be representative of one or more circuits configured to receive standby mode indication 111, determine the type of the standby mode based on standby mode indication 111, determine early wake value 121 based on standby mode indication 111 and the type of the standby mode, and output early wake value 121 to interrupt generation circuit(s) 125. In various embodiments, early wake value 121 may include a value corresponding to the standby mode. For example, early wake value 121 may indicate a time duration required by interrupt servicing circuit 105 to exit the standby mode. In some such embodiments, early wake value 121 may include a first value (e.g., 10 µs) based on standby mode indication 111 indicating a standby fast mode and a second value (e.g., 100 µs) based on standby mode indication 111 indicating a standby slow mode. Other standby modes may also be contemplated, such as a standby medium mode (e.g., 50 µs), as well as combinations and variations thereof.

Interrupt generation circuits 125 may be representative of one or more circuits, e.g., peripheral circuits, capable of performing various operations as directed by interrupt servicing circuit 105, among other processing devices, and producing output signals 130 based on performing respective operations. Examples of interrupt generation circuits 125 may include one or more analog-to-digital converters (ADCs), digital-to-analog converters (DACs), communication devices (e.g., serial communication modules, e.g., transmitters, receivers, transceivers), and the like, as well as combinations and variations thereof.

Interrupt generation circuits 125 may be configured to receive early wake value 121 and determine a lead time based on early wake value 121. In various embodiments, the lead time may include and refer to an amount of time based on early wake value 121 corresponding to how long interrupt generation circuits 125 may generate and output early wake signal 126 prior to generating and outputting interrupt signal 128. In some such embodiments, to determine the lead time, interrupt generation circuits 125 may determine a reference point (e.g., a point during an operational process of interrupt generation circuit 125), determine a duration based on a clock frequency of a clock signal provided to interrupt generation circuits 125 (e.g., one of clock signals 116), and determine the lead time relative to the reference point based on the duration.

In some such embodiments, interrupt generation circuits 125 may include a memory, such as a buffer memory (e.g., a first-in-first-out (FIFO) buffer memory), that may store output signals 130 (e.g., data), or portions thereof, while interrupt generation circuits 125 perform respective operations. As interrupt generation circuits 125 performs respective operations, interrupt generation circuits 125 may store data on the buffer memory, and based on a capacity status of the buffer memory, may transfer the stored data out of the buffer memory (e.g., via direct memory access (DMA) to interrupt servicing circuit for processing). In such embodiments, interrupt generation circuits 125 may generate interrupt signal 128 according to the capacity of the buffer memory. For example, interrupt generation circuits 125 may generate interrupt signal 128 when the buffer memory is full, and the stored data is ready to be moved out of the buffer memory to interrupt servicing circuit 105. This way, interrupt servicing circuit 105 may be triggered to invoke an interrupt service routine when receiving interrupt signal 128 to process the received data. Thus, to determine the reference point, interrupt generation circuits 125 may be configured to determine the reference point based on an occupancy level of the buffer memory (e.g., based on a full occupancy of the buffer memory). More specifically, interrupt generation circuits 125 may determine the reference point based on a current capacity of the buffer memory, a total size of the buffer memory, and a remaining capacity of the buffer memory based on the current capacity and the total size. In such an example, the lead time may refer to an amount of time it may take interrupt generation circuits 125 to fill the remaining capacity of the buffer memory with data, which may be based on the clock frequency of the clock signal with which interrupt generation circuit 125 operates, among other parameters of interrupt generation circuits 125 (e.g., a resolution of interrupt generation circuits 125). Note that the above is provided only as examples for purposes of illustration. In some embodiments, interrupt generation circuits 125 may determine the lead time relative to other reference points other than the occupancy of a buffer memory. For example, in some embodiments, interrupt generation circuits 125 may determine the lead time relative to a pre-determined, or software-defined, schedule, such that interrupt generation circuits 125 may generate interrupt signal 128 periodically on a fixed schedule and separate early wake signal 126 before interrupt signal 128 so as to wake up interrupt servicing circuit 105 ahead of time.

Based on determining the lead time, interrupt generation circuits 125 may be configured to generate early wake signal 126 and output early wake signal 126 at a time corresponding to the lead time relative to the reference point. Early wake signal 126 may indicate that interrupt generation circuits 125 may generate interrupt signal 128 at a time subsequent to outputting early wake signal 126. In some such embodiments, early wake signal 126 may indicate that interrupt generation circuits 125 may be nearly full capacity of the buffer memory and may require interrupt servicing by interrupt servicing circuit 105. Based on receiving early wake signal 126, standby mode control circuit 120 may be configured to generate and output wake mode signal 127 to power control circuit 110.

Power control circuit 110 may once again be configured to control clock generation circuit 115 and PMU 117 via clock control signal 112 and power control signal 113, respectively, based on receiving wake mode signal 127. Clock generation circuit 115 can output clock signals 116 and PMU can output supply voltages 118 based on clock control signal 112 and power control signal 113, respectively, which, when received by interrupt servicing circuit 105, may cause interrupt servicing circuit 105 to exit the standby mode and enter the active mode before interrupt generation circuits 125 generates and outputs interrupt signal 128. Advantageously, interrupt servicing circuit 105 may be ready to operate in the active mode at the time when interrupt signal 128 is received by interrupt servicing circuit 105, and thus, latency and delay issues caused by transitioning between power modes may be eliminated or reduced.

Subsequent to interrupt generation circuits 125 outputting early wake signal 126 and power control circuit 110 controlling clock generation circuit 115 and PMU 117 to cause interrupt servicing circuit 105 to exit the standby mode and enter the active mode, interrupt generation circuits 125 may generate and output interrupt signal 128. Interrupt servicing circuit 105 may receive interrupt signal 128 and perform one or more interrupt service routine operations. For example, interrupt servicing circuit 105 may also receive output signals 130 in conjunction with interrupt signal 128, which may represent various data generated by interrupt generation circuits 125 (e.g., analog samples, digital output, etc.), and thus may process output signals 130 during the interrupt service routine operations. In some embodiments, after interrupt servicing circuit 105 performs the interrupt service routine operations, interrupt servicing circuit 105 may want to return to a standby mode and thus output mode indication signal 106 indicating the standby mode. Power control circuit 110 may receive the mode indication signal 106 and control clock generation circuit 115 and PMU 117 via clock control signal 112 and power control signal 113, respectively, to cause interrupt servicing circuit 105 to exit the active mode and re-enter the standby mode indicated by mode indication signal 106.

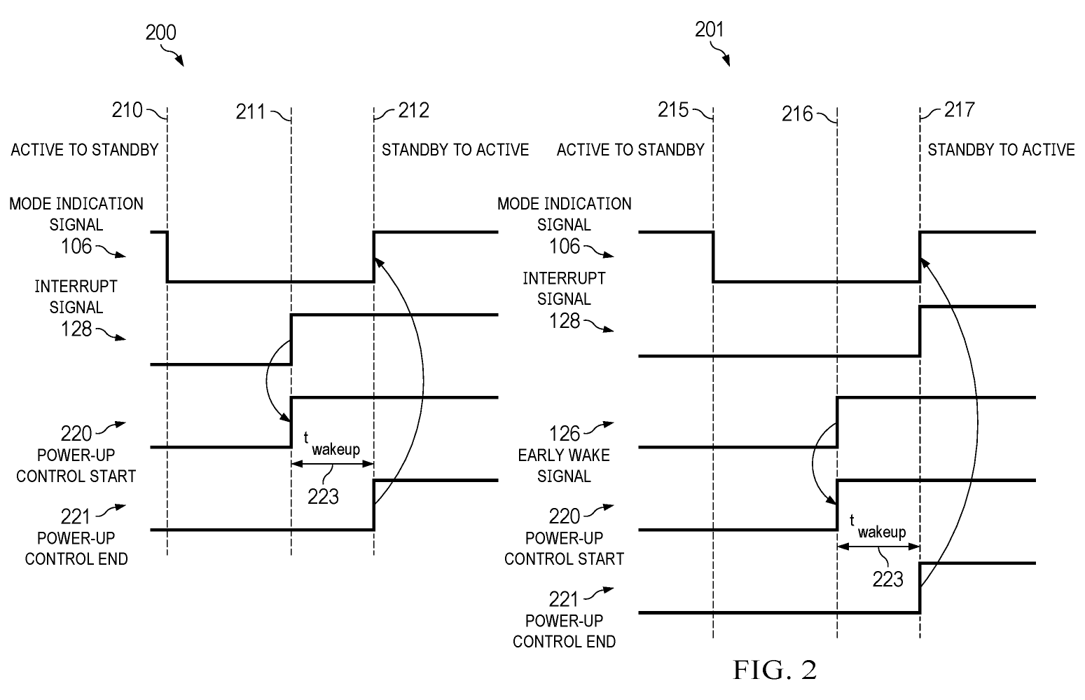

FIG. 2 illustrates example timing diagrams with respect to transitioning between power modes of a processing system in an implementation. FIG. 2 shows timing diagrams 200 and 201. Timing diagram 200 illustrates a transition between a standby mode to an active mode without the use of an early wake signal by elements of a system (e.g., a system in existing solutions as described above), and timing diagram 201 illustrates a transition between a standby mode to an active mode using an early wake signal generated by elements of a system (e.g., system 100).

In various embodiments, timing diagrams 200 and 201 may illustrate states of the modes, signals, and the like with logical state values. For example, in timing diagrams 200 and 201, a logical high state (e.g., a high logical value, e.g., 1) may represent that a signal or mode is enabled, while a logical low state (e.g., a low logical value, e.g., 0) may represent that a signal or mode is disabled.

Referring first to timing diagram 200, timing diagram 200 illustrates a set of logical waveforms associated with an existing system that might not include elements, such as standby mode control circuit 120, among other elements, configured to perform standby mode transition processes using early wake signals. Timing diagram 200 includes logical waveforms corresponding to mode indication signal 106, interrupt signal 128, power-up control start 220, and power-up control end 221.

Mode indication signal 106 may indicate the active mode based on including a high logical value and a standby mode based on including a low logical value. Interrupt signal 128 may indicate an interrupt output by interrupt generation circuits 125 based on including a high logical value. Power-up control start 220 may refer to a first time at which power management circuitry, such as clock generation circuit 115 and PMU 117, receives respective control signals and begin to generate respective output signals (e.g., to ramp up clock signal frequency and supply voltage level) to cause interrupt servicing circuit 105 to exit a standby mode and enter an active mode. The power management circuitry may begin to generate clock signals and supply voltages when power-up control start 220 includes a high logical value. Power-up control end 221 may refer to a second time at which the power management circuitry outputs respective signals and interrupt servicing circuit 105 exits the standby mode and enters the active mode. The power management circuitry may have finished ramping up clock signals and supply voltages based on power-up control end 221 including a high logical value.

At time 210, interrupt servicing circuit 105 may transition from an active mode to a standby mode, and thus, mode indication signal 106 output by interrupt servicing circuit 105 may transition from the high logical state to the low logical state. At time 211, interrupt generation circuits 125 may output interrupt signal 128 having a high logical value. Based on interrupt signal 128, power control circuit 110 may be configured to control clock generation circuit 115 and PMU 117 via clock control signal 112 and power control signal 113, respectively, to generate clock signals 116 and supply voltages 118, respectively, to cause interrupt servicing circuit 105 to exit the standby mode. Accordingly, at time 211, power-up control start 220 transitions from the low logical state to the high logical state.

At time 212, clock generation circuit 115 and PMU 117 may output clock signals 116 and supply voltages 118 to have caused interrupt servicing circuit 105 to transition to the active mode. Accordingly, power-up control end 221 and mode indication signal 106 may transition from the low logical states to the high logical states as interrupt servicing circuit 105 exits the standby mode to enter the active mode and outputs mode indication signal 106 including an indication thereof.

The time it takes clock generation circuit 115 and PMU 117 to generate and output respective signals and interrupt servicing circuit 105 to transition from the standby mode into the active mode (i.e., the time between power-up control start 220 transitioning to the high logical state and power-up control end 221 transitioning to the high logical state) may be referred to as wake-up time 221. Assuming that power-up control start 220 transitions to the high logical state at the same time interrupt signal 128 is output by interrupt generation circuits 125, delay 223 may be introduced. Delay 223 may correspond to the time between interrupt servicing circuit 105 receiving interrupt signal 128 and interrupt servicing circuit 105 entering the active mode. Problematically, based on delay 223, interrupt servicing circuit 105 might not be ready to perform an interrupt service routine once receiving interrupt signal 128 until interrupt servicing circuit 105 can actually enter the active mode, which may create issues and latency for the interrupt routine servicing required by interrupt signal 128.

To eliminate delay 223, as described above, system 100 includes various elements configured to output early wake signal 126, which may precede interrupt signal 128 and provide power control circuit 110, clock generation circuit 115, and PMU 117 to output respective signals to cause interrupt servicing circuit 105 to exit the standby mode and enter the active mode before interrupt servicing circuit 105 receives interrupt signal 128.

By way of example, in timing diagram 201, at time 215, interrupt servicing circuit 105 may transition from an active mode to a standby mode, and thus, mode indication signal 106 output by interrupt servicing circuit 105 may transition from the high logical state to the low logical state. At time 216, interrupt generation circuits 125 may output early wake signal 126 based on factors described above with respect to FIG. 1, and thus, early wake signal 126 may transition from the low logical state to the high logical state. Based on early wake signal 126, power control circuit 110 may be configured to control clock generation circuit 115 and PMU 117 via clock control signal 112 and power control signal 113, respectively, to generate clock signals 116 and supply voltages 118 (e.g., to ramp up clock signal frequency and supply voltage level), respectively. At time 217, a time after time 216, clock generation circuit 115 and PMU 117 may output respective signals to cause interrupt servicing circuit 105 to enter the active mode as indicated by mode indication signal 106 and power-up control end 221. At or after this time, interrupt generation circuits 125 may output interrupt signal 128. Based on being in the active mode at the time interrupt signal 128 is output, interrupt servicing circuit 105 can service interrupt generation circuits 125 immediately after receiving interrupt signal 128 without delay.

FIGS. 3A and 3B illustrates a series of steps for generating early wake signals to adaptively transition out of a standby mode during operation of a processing system in an implementation. FIG. 3A shows method 300, and FIG. 3B shows method 301, both of which include a series of steps performed by one or more elements of a system, such as elements of system 100 of FIG. 1, and thus, reference elements of FIG. 1.

Referring first to method 300 of FIG. 3A, in operation 305, standby mode control circuit 120 may be configured to receive standby mode indication 111 indicative of a standby mode (e.g., a standby fast mode, a standby slow mode). In various embodiments, standby mode indication 111 may be an indication based on mode indication signal 106 output by interrupt servicing circuit 105 that indicates the standby mode. Standby mode control circuit 120 may further be configured to determine the type of the standby mode.

In operation 310, standby mode control circuit 120 may be configured to determine early wake value 121 based on standby mode indication 111 (e.g., the type of the standby mode), and output early wake value 121 to interrupt generation circuit(s) 125. In various embodiments, early wake value 121 may include a value corresponding to the standby mode. In some such embodiments, early wake value 121 may include a first value (e.g., 10 µs) based on standby mode indication 111 indicating a standby fast mode and a second value (e.g., 100 µs) based on standby mode indication 111 indicating a standby slow mode. In other words, since interrupt servicing circuit 105 may take a longer time to exit the standby slow mode than the standby fast mode, standby mode control circuit 120 may accordingly generate different early wake values 121 to wake up interrupt servicing circuit 105 after different times prior to receiving interrupt signal 128.

Interrupt generation circuits 125 may be representative of one or more circuits, e.g., one or more peripheral circuits, capable of performing various operations as directed by interrupt servicing circuit 105, among other processing devices, and producing output signals 130 based on performing respective operations. Examples of interrupt generation circuits 125 may include one or more analog-to-digital converters (ADCs), digital-to-analog converters (DACs), communication devices (e.g., serial communication modules, e.g., transmitters, receivers, transceivers), and the like, as well as combinations and variations thereof.

In operation 315, interrupt generation circuits 125 may be configured to receive early wake value 121 and determine a lead time based on early wake value 121. In various embodiments, the lead time may include and refer to an amount of time based on early wake value 121 and corresponding to how long interrupt generation circuits 125 may generate and output early wake signal 126 prior to generating and outputting interrupt signal 128. In some such embodiments, to determine the lead time, interrupt generation circuits 125 may determine a reference point (e.g., corresponding to a point-in-time when interrupt generation circuits 125 generate interrupt signal 128), determine a duration based on a clock frequency of a clock signal provided to interrupt generation circuits 125 (e.g., one of clock signals 116) and early wake value 121 (received from standby mode control circuit 120), and determine the lead time relative to the reference point based on the duration.

In some such embodiments, interrupt generation circuits 125 may include a memory, such as a buffer memory (e.g., a first-in-first-out (FIFO) buffer memory), that may store output signals 130 (e.g., data), or portions thereof, while interrupt generation circuits 125 perform respective operations. As interrupt generation circuits 125 performs respective operations, interrupt generation circuits 125 may store data on the buffer memory, and based on a capacity status of the buffer memory, transfer the stored data out of the buffer memory (e.g., to interrupt generation circuit 125 for processing). In such embodiments, to determine the reference point, interrupt generation circuits 125 may be configured to determine the reference point based on an occupancy level of the buffer memory (e.g., based on a full occupancy of the buffer memory). More specifically, interrupt generation circuits 125 may determine the reference point based on a current capacity of the buffer memory, a total size of the buffer memory, and a remaining capacity of the buffer memory based on the current capacity and the total size. In such an example, the lead time may refer to an amount of time it may take interrupt generation circuits 125 to fill the remaining capacity of the buffer memory with data, which may be based on the clock frequency of the clock signal with which interrupt generation circuit 125 operates, among other parameters of interrupt generation circuits 125 (e.g., a resolution of interrupt generation circuits 125). Thus, when interrupt generation circuits 125 operate at different frequencies, they may determine the lead time of different values. In other words, the lead time may be determined corresponding to the variable throughput operations of interrupt generation circuits 125.

Based on determining the lead time, interrupt generation circuits 125 may be configured to generate early wake signal 126 and output early wake signal 126 at a time corresponding to the lead time relative to the reference point. Early wake signal 126 may indicate that interrupt generation circuits 125 may generate interrupt signal 128 at a time subsequent to outputting early wake signal 126. In some such embodiments, early wake signal 126 may indicate that interrupt generation circuits 125 may be nearly full capacity of the buffer memory and may require interrupt servicing by interrupt servicing circuit 105. Based on receiving early wake signal 126, standby mode control circuit 120 may be configured to generate and output wake mode signal 127 to power control circuit 110 for control of power management circuitry (e.g., clock generation circuit 115, PMU 117) to adjust clock signals 116 and supply voltages 118 to thus cause interrupt servicing circuit 105 to exit the standby mode and enter the active mode.

In operation 325, subsequent to interrupt generation circuits 125 generating and outputting early wake signal 126, interrupt generation circuits 125 may be configured to generate and output interrupt signal 128 to interrupt servicing circuit 105 for servicing of interrupt generation circuits 125 based on performing one or more interrupt service routine operations. For example, as described above, in some embodiments, interrupt generation circuits 125 may further provide output signals 130 (e.g., representing various data) for interrupt servicing circuit 105 to process during the interrupt service routine operations.

Referring next to method 301 of FIG. 3B, in operation 330, interrupt servicing circuit 105 enters a standby mode and outputs mode indication signal 106 indicating the standby mode. In some embodiments, mode indication signal 106 may indicate the standby fast mode. In some embodiments, mode indication signal 106 may indicate the standby slow mode. In some embodiments, interrupt servicing circuit 105 enters the standby mode based on clock signals 116 and supply voltages 118 from clock generation circuit 115 and PMU 117, respectively, as controlled by power control circuit 110.

In operation 335, power control circuit 110 receives mode indication signal 106 and outputs standby mode indication 111 based on mode indication signal 106. Standby mode indication 111 may include an indication of the standby mode (e.g., a standby fast mode, a standby slow mode, a standby medium mode, etc.). In some embodiments, power control circuit 110 may be configured to control clock generation circuit 115 and PMU 117 via clock control signal 112 and power control signal 113, respectively, to cause interrupt servicing circuit 105 to enter the standby mode. In some embodiments, interrupt servicing circuit 105 may be in the standby mode, and, as such, power control circuit 110 might not control operations of clock generation circuit 115 and PMU 117 any further.

In operation 340, standby mode control circuit 120 may be configured to receive standby mode indication 111 and determine the type of the standby mode based on standby mode indication 111. In operation 345, standby mode control circuit 120 may be configured to determine early wake value 121 based on standby mode indication 111 and the type of the standby mode, and output early wake value 121 to interrupt generation circuit(s) 125. In various embodiments, early wake value 121 may include a value corresponding to the standby mode. In some such embodiments, early wake value 121 may include a first value (e.g., 10 µs) based on standby mode indication 111 indicating a standby fast mode and a second value (e.g., 100 µs) based on standby mode indication 111 indicating a standby slow mode.

In operation 350, interrupt generation circuits 125 may be configured to receive early wake value 121 and determine a lead time based on early wake value 121. In various embodiments, the lead time may include and refer to an amount of time based on early wake value 121 and corresponding to how long interrupt generation circuits 125 may generate and output early wake signal 126 prior to generating and outputting interrupt signal 128. In some such embodiments, to determine the lead time, interrupt generation circuits 125 may determine a reference point (e.g., a point during an operational process of interrupt generation circuit 125), determine a duration based on a clock frequency of a clock signal provided to interrupt generation circuits 125 (e.g., one of clock signals 116) and early wake value 121 , and determine the lead time relative to the reference point based on the duration, such as described above.

Based on determining the lead time, in operation 355, interrupt generation circuits 125 may be configured to generate early wake signal 126 and output early wake signal 126 at a time corresponding to the lead time relative to the reference point. Early wake signal 126 may indicate that interrupt generation circuits 125 may generate interrupt signal 128 at a time subsequent to outputting early wake signal 126. In some such embodiments, early wake signal 126 may indicate that interrupt generation circuits 125 may be nearly full capacity of the buffer memory and may require interrupt servicing by interrupt servicing circuit 105.

In operation 360, standby mode control circuit 120 may be configured to receive early wake signal 126, and based on receiving early wake signal 126, standby mode control circuit 120 may be configured to generate and output wake mode signal 127 to power control circuit 110 for control of power management circuitry (e.g., clock generation circuit 115, PMU 117) to cause interrupt servicing circuit 105 to exit the standby mode and enter the active mode.

More specifically, in operation 365, power control circuit 110 may receive wake mode signal 127 and output clock control signal 112 and power control signal 113 to clock generation circuit 115 and PMU 117, respectively, to control operations thereof. Based on clock control signal 112, clock generation circuit 115 may generate and output clock signals 116 with which interrupt servicing circuit 105 may use to enter the active mode. Further, based on power control signal 113, PMU 117 may generate supply voltages 118 with which interrupt servicing circuit 105 may use to enter the active mode.

In operation 370, subsequent to interrupt generation circuits 125 generating and outputting early wake signal 126, interrupt generation circuits 125 may be configured to generate interrupt signal 128 and output interrupt signal 128 to interrupt servicing circuit 105 for servicing of interrupt generation circuits 125 based on performing one or more interrupt service routine operations. In operation 375, interrupt servicing circuit 105 may perform the one or more interrupt service routine operations based on interrupt signal 128. At this time, interrupt servicing circuit 105 may already exit the standby mode and be ready to operate in the active mode when interrupt generation circuits 125 outputs interrupt signal 128. Advantageously, interrupt servicing circuit 105 may perform the interrupt service routine operations without latency.

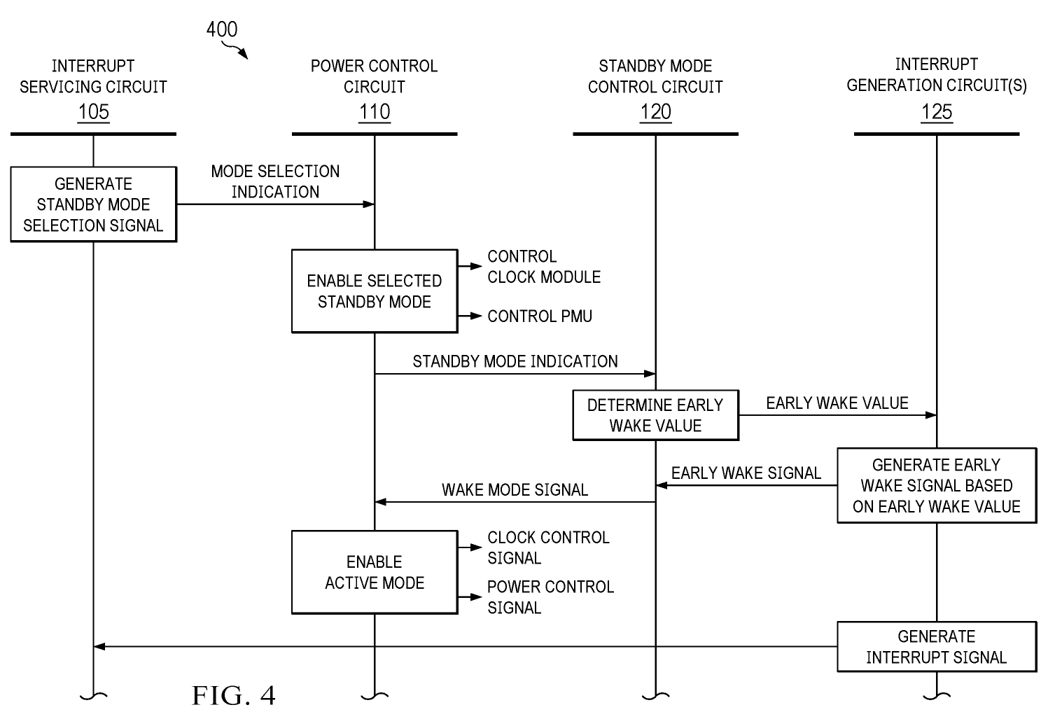

FIG. 4 illustrates a sequence diagram for adaptively transitioning between power modes of a processing system in an implementation. FIG. 4 shows sequence diagram 400, which references elements of FIG. 1, such as interrupt servicing circuit 105, power control circuit 110, standby mode control circuit 120, and interrupt generation circuit(s) 125. FIG. 4 illustrates operations of these elements at different points-in-time, where an operation performed in an earlier time is shown at a vertically higher position in the figure.

In sequence diagram 400, to begin, interrupt servicing circuit 105 enters a standby mode and outputs mode indication signal 106 indicating the standby mode. In some embodiments, mode indication signal 106 may indicate the standby fast mode. In some embodiments, mode indication signal 106 may indicate the standby slow mode. In some embodiments, interrupt servicing circuit 105 enters the standby mode based on clock signals 116 and supply voltages 118 from clock generation circuit 115 and PMU 117, respectively, as controlled by power control circuit 110.

Power control circuit 110 receives mode indication signal 106 and outputs standby mode indication 111 based on mode indication signal 106. Standby mode indication 111 may include an indication of the standby mode (e.g., a standby fast mode, a standby slow mode). In some embodiments, power control circuit 110 may be configured to control clock generation circuit 115 and PMU 117 via clock control signal 112 and power control signal 113, respectively, to cause interrupt servicing circuit 105 to enter the standby mode. In some embodiments, interrupt servicing circuit 105 may have already entered in the standby mode, and, as such, power control circuit 110 might not further adjust operations of clock generation circuit 115 and PMU 117 any further.

Standby mode control circuit 120 may be configured to receive standby mode indication 111, determine the type of the standby mode based on standby mode indication 111, and determine early wake value 121 based on standby mode indication 111 (e.g., the type of the standby mode), and output early wake value 121 to interrupt generation circuit(s) 125. In various embodiments, early wake value 121 may include a value corresponding to the standby mode. In some such embodiments, early wake value 121 may include a first value (e.g., 10 µs) based on standby mode indication 111 indicating a standby fast mode and a second value (e.g., 100 µs) based on standby mode indication 111 indicating a standby slow mode.

Interrupt generation circuits 125 may be configured to receive early wake value 121 and determine a lead time based on early wake value 121. In various embodiments, the lead time may include and refer to an amount of time based on early wake value 121 corresponding to how long interrupt generation circuits 125 may generate and output early wake signal 126 prior to generating and outputting interrupt signal 128. In some such embodiments, to determine the lead time, interrupt generation circuits 125 may determine a reference point (e.g., corresponding to a point-in-time when interrupt generation circuits 125 generate interrupt signal 128), determine a duration based on a clock frequency of a clock signal provided to interrupt generation circuits 125 (e.g., one of clock signals 116), and determine the lead time relative to the reference point based on the duration, such as described above.

Based on determining the lead time, interrupt generation circuits 125 may be configured to generate early wake signal 126 and output early wake signal 126 at a time corresponding to the lead time relative to the reference point. Early wake signal 126 may indicate that interrupt generation circuits 125 may generate interrupt signal 128 at a time subsequent to outputting early wake signal 126. In some such embodiments, early wake signal 126 may indicate that interrupt generation circuits 125 may be nearly full capacity of the buffer memory and may require interrupt servicing by interrupt servicing circuit 105.

Standby mode control circuit 120 may be configured to receive early wake signal 126, and based on receiving early wake signal 126, standby mode control circuit 120 may be configured to generate and output wake mode signal 127 to power control circuit 110 for control of power management circuitry (e.g., clock generation circuit 115, PMU 117) to cause interrupt servicing circuit 105 to exit the standby mode and enter the active mode.

More specifically, power control circuit 110 may receive wake mode signal 127 and output clock control signal 112 and power control signal 113 to clock generation circuit 115 and PMU 117, respectively, to control operations thereof. Based on clock control signal 112, clock generation circuit 115 may generate and output clock signals 116 with which interrupt servicing circuit 105 may use to enter the active mode. Further, based on power control signal 113, PMU 117 may generate supply voltages 118 with which interrupt servicing circuit 105 may use to enter the active mode.

Subsequent to interrupt generation circuits 125 generating and outputting early wake signal 126, interrupt generation circuits 125 may be configured to generate interrupt signal 128 and output interrupt signal 128 to interrupt servicing circuit 105 for servicing of interrupt generation circuits 125 based on performing one or more interrupt service routine operations. Interrupt servicing circuit 105 may perform the one or more interrupt service routine operations based on interrupt signal 128. At this time, interrupt servicing circuit 105 may be operating in the active mode when interrupt generation circuits 125 outputs interrupt signal 128. Advantageously, interrupt servicing circuit 105 may perform the interrupt service routine operations without latency.

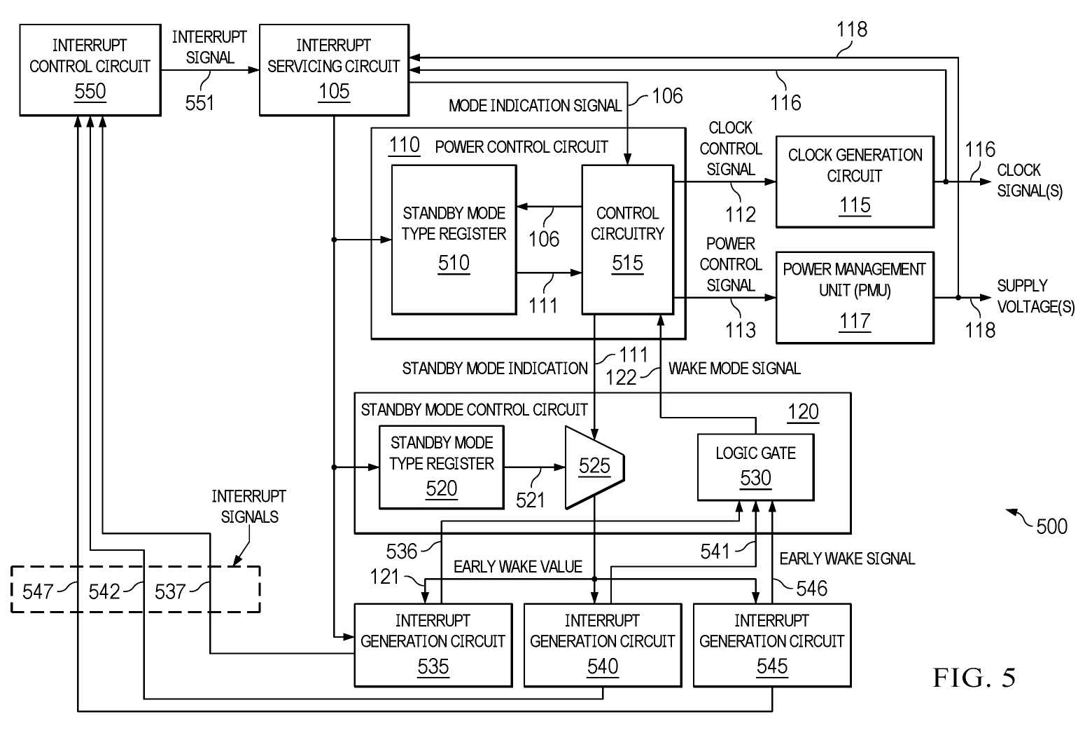

FIG. 5 illustrates an example system configurable to perform adaptive wake-up processes in an implementation. FIG. 5 shows system 500, which includes and references elements of FIG. 1 as well as other elements. System 500 includes interrupt servicing circuit 105, power control circuit 110, clock generation circuit 115, PMU 117, standby mode control circuit 120, interrupt generation circuits 535, 540, and 545, and interrupt control circuit 550. In various embodiments, elements of system 500 may be configured to perform mode transitioning processes, such as operations of methods 300 and 301 of FIGS. 3A and 3B, respectively.

In various embodiments, system 500 may be representative of a processing system capable of operating in multiple power modes and performing interrupt service routine (ISR) operations in an active mode of the power modes. Elements of system 500 may include dedicated, fixed-purpose hardware components capable of performing power mode transition operations, such as operations of methods 300 and 301 of FIGS. 3A and 3B, respectively. System 500 may be embodied in circuitry utilized in an embedded system, an integrated circuit, a field-programmable gate array, and/or a system-on-chip (SoC), such as a microcontroller unit (MCU). In some embodiments, elements of system 500 may be located onboard an integrated circuit. In some such embodiments, some elements of system 500 may be off-chip relative to other elements of the system onboard the integrated circuit.

Interrupt servicing circuit 105 may be included and may be configured to receive clock signal(s) 116 and supply voltage(s) 118 from clock generation circuit 115 and PMU 117, respectively, and operate in a mode based on clock signal(s) 116 and supply voltage(s) 118. In various embodiments, interrupt servicing circuit 105 may be representative of one or more processing devices, circuits, cores, or systems capable of executing program instructions and enabling functionality of system 100 based on executing the program instructions. Examples of interrupt servicing circuit 105 may include one or more general purpose processors, central processing units (CPUs), digital signal processors (DSPs), application-specific integrated circuits (ASICs), field-programmable logic arrays (FPGAs), and the like.

Based on receiving clock signals 116 and supply voltages 118, interrupt servicing circuit 105 may be configured to operate in a mode, such as an active mode or a low power mode (e.g., a standby mode). Interrupt servicing circuit 105 may output mode indication signal 106 that indicates the operating mode of interrupt circuit 105 to power control circuit 110.

Power control circuit 110 may be representative of one or more circuits capable of controlling clock generation circuit 115 and PMU 117 based on signals provided by interrupt servicing circuit 105 (e.g., mode indication signal 106) and by standby mode control circuit 120 (e.g., wake mode signal 127). Power control circuit 110 may be coupled to interrupt servicing circuit 105 to receive mode indication signal 106 and may further be coupled to clock generation circuit 115, PMU 117, and to standby mode control circuit 120.

Power control circuit 110 may include standby type register 510 and control circuitry 515. Standby type register 510 may be configured to store data, or locations therewith, related to types of standby modes, such as a standby fast mode, a standby slow mode, and more. Control circuitry 515 may be representative of one or more circuits configured to control clock generation circuit 115 and PMU 117.

In operation, control circuitry 515 may receive mode indication signal 106 and provide mode indication signal 106 to standby mode type register 510 to determine standby mode indication 111, which may indicate the type of standby mode associated with mode indication signal 106. Based on mode indication signal 106 and standby mode indication 111, control circuitry 515 may control clock generation circuit 115 and PMU 117 to produce clock signals 117 and supply voltages 118 via clock control signal 112 and power control signal 113, respectively, according to the standby mode, which may cause interrupt servicing circuit 105 to enter the standby mode (if not already in the standby mode). In various embodiments, clock control signal 112 may include an indication of a subset of clock signals, and/or clock frequencies thereof, for clock generation circuit 115 to enable. Similarly, power control signal 113 may include an indication of a subset of supply voltages (e.g., supply rails), and/or voltages thereof, for PMU 117 to enable. Based on clock signals 116 and supply voltages 118, power control circuit 110 may cause interrupt servicing circuit 105 to enter into multiple different types of standby modes, including a standby fast mode and a standby slow mode, as well as an active mode.

The standby fast mode may refer a standby mode in which power control circuit 110 controls clock generation circuit 115 to enable and output a first subset of clock signals and in which power control circuit 110 controls PMU 117 to enable and output a first subset of supply voltages. The standby slow mode may refer a standby mode in which power control circuit 110 controls clock generation circuit 115 to enable and output a second subset of clock signals and in which power control circuit 110 controls PMU 117 to enable and output a second subset of supply voltages. The second subset of clock signals may include a fewer number of clock signals or may include one or more clock signals having a lower frequency relative to clock signals of the first subset of clock signals, and the second subset of supply voltages may include a fewer number of supply voltages or may include one or more supply voltages of a lower voltage relative to the supply voltages of the first subset of supply voltages. It follows that, in the standby slow mode, system 100 may consume less power than in the standby fast mode based on the clock signals, frequencies thereof, and the supply voltages used in respective modes. In the active mode, power control circuit 110 may control clock generation circuit 115 and PMU 117 to output high frequency clock signals and supply voltages, respectively, to enable run-time operations of interrupt servicing circuit 105.

Control circuitry 515 may provide standby mode indication 111 to standby mode control circuit 120. Standby mode control circuit 120 may be representative of one or more circuits configured to receive standby mode indication 111, determine the type of the standby mode based on standby mode indication 111, determine early wake value 121 based on standby mode indication 111 and the type of the standby mode, and output early wake value 121 to interrupt generation circuit(s) 125. Standby mode control circuit 120 may include standby type register 520, multiplexer 525, and logic gate 530. Standby type register 520 may be configured to store data, or locations therewith, related to early wake values. Multiplexer 525 may be configured to selectively output early wake value 121 based on a set of early wake values 521 and based on standby mode indication 111. Multiplexer 525 may be coupled to each of interrupt generation circuits 535, 540, and 545 and may output early wake value 121 to each of the circuits. In various embodiments, early wake value 121 may include a value corresponding to the standby mode. In some such embodiments, early wake value 121 may include a first value (e.g., 10 µs) based on standby mode indication 111 indicating a standby fast mode and a second value (e.g., 100 µs) based on standby mode indication 111 indicating a standby slow mode.

Interrupt generation circuits 535, 540, and 545 may be representative of same or different peripheral device capable of performing various operations as directed by interrupt servicing circuit 105, among other processing devices, and producing output signals based on performing respective operations. Examples of interrupt generation circuits 535, 540, and 545 may include one or more analog-to-digital converters (ADCs), digital-to-analog converters (DACs), communication devices (e.g., serial communication modules, e.g., transmitters, receivers, transceivers), and the like, as well as combinations and variations thereof.

Interrupt generation circuits 535, 540, and 545 may be configured to receive early wake value 121 and determine respective lead times based on early wake value 121. In various embodiments, the lead times may include and refer to an amount of time based on early wake value 121 corresponding to how long a given interrupt generation circuit may generate and output an early wake signal (e.g., early wake signals 536, 541, and 546) prior to generating and outputting an interrupt signal (e.g., interrupt signal 537, 542, and 547). In some such embodiments, to determine the lead time, each interrupt generation circuit may determine a reference point (e.g., a point during an operational process of a respective interrupt generation circuit), determine a duration based on a clock frequency of a clock signal provided to the respective interrupt generation circuit (e.g., one of clock signals 116), and determine the lead time relative to the reference point based on the duration. Thus, in such embodiments, interrupt generation circuits 535, 540, and 545 may receive the same early wake value 121 (e.g., broadcast from standby mode control circuit 120) and determine respective lead times based on their particular operational situations (e.g., respective clock frequencies, respective capacity of buffer memory, etc.). In other words, interrupt generation circuits 535, 540, and 545 may determine the lead times corresponding to different throughput operations.

In some such embodiments, each interrupt generation circuit may include a memory, such as a buffer memory (e.g., a first-in-first-out (FIFO) buffer memory), that may store data while interrupt generation circuits 535, 540, and 545 perform respective operations. As interrupt generation circuits 535, 540, and 545 perform respective operations, each interrupt generation circuit may store data on a respective buffer memory, and based on completing an operation, the interrupt generation circuits may reach a capacity of a respective buffer memory. In such embodiments, to determine the reference point, each interrupt generation circuit may be configured to determine the reference point based on an occupancy of the buffer memory (e.g., based on a full occupancy of the buffer memory). More specifically, each interrupt generation circuit may determine the reference point based on a current capacity of a respective buffer memory, a total size of a respective buffer memory, and a remaining capacity of a respective buffer memory based on the current capacity and the total size. In such an example, the lead time may refer to an amount of time it may take the interrupt generation circuits to fill the remaining capacity of a respective buffer memory with data, which may be based on a clock frequency of a respective clock signal with which a particular interrupt generation circuit operates, among other parameters of the interrupt generation circuits (e.g., a resolution, a sample time). As described above, the above are provided only as examples for purposes of illustration. In some embodiments, the lead time may be determined relative to various reference points, e.g., a predetermined schedule.

Based on determining the lead time, interrupt generation circuits 535, 540, and 5455 may be configured to generate and output early wake signals 536, 541, and 546, respectively, at times corresponding to respective lead times relative to respective reference points. Early wake signals 536, 541, and 546 may each include an indication that a respective interrupt generation circuit may generate an interrupt signal at a time subsequent to outputting the early wake signal. In some such embodiments, early wake signals 536, 541, and 546 may indicate that a respective interrupt generation circuit may be nearly full capacity of a respective buffer memory and may require interrupt servicing by interrupt servicing circuit 105. In some embodiments, interrupt generation circuits 535, 540, and 545 may output respective early wake signals at different times. In some embodiments, interrupt generation circuits 535, 540, and 545 may output respective early wake signals at the same time. Other combinations and variations may be contemplated.

Logic gate 530 of standby mode control circuit 120 may receive one or more of early wake signals 536, 541, and 546 at a time and may be configured to output wake mode signal 122 based on receiving any one or more of the early wake signals. In various embodiments, logic gate 530 may be representative of a digital logic gate, such as an OR gate, an AND gate, a multiplexer, etc. that may be configured to receive early wake signals 536, 541, and 546, and output wake mode signal 122 based on early wake signals 536, 541, and/or 546. For example, logic gate 530 may output wake mode signal 122 based on an OR or AND combination of one or more of the received early wake signals. Or logic gate 530 may select one of the received early wake signals based on a priority to output wake mode signal 122. As such, regardless of which early wake signal is received by logic gate 530 first, logic gate 530 may be configured to output wake mode signal 122, which may indicate an early wake event to control circuitry 515 of power control circuit 110.

Based on wake mode signal 122, control circuitry 515 of power control circuit 110 may once again be configured to control clock generation circuit 115 and PMU 117 via clock control signal 112 and power control signal 113, respectively, based on receiving wake mode signal 127. Clock generation circuit 115 can output clock signals 116 and PMU can output supply voltages 118 based on clock control signal 112 and power control signal 113, respectively, which, when received by interrupt servicing circuit 105, may cause interrupt servicing circuit 105 to exit the standby mode and enter the active mode before interrupt generation circuits 535, 540, and 545 generate and output interrupt signals 537, 542, and 547, respectively. Advantageously, interrupt servicing circuit 105 may be operating in the active mode at the time that one or more of the interrupt generation circuits output a respective interrupt signal, and thus, latency and delay issues may be eliminated or reduced caused by transitioning between power modes when an interrupt signal is received by interrupt servicing circuit 105.

Subsequent to one or more of interrupt generation circuits 535, 540, and/or 545 outputting a respective early wake signal and power control circuit 110 controlling clock generation circuit 115 and PMU 117 to cause interrupt servicing circuit 105 to exit the standby mode and enter the active mode, one or more of interrupt generation circuits 535, 540, and 545 may generate and output interrupt signals 537, 542, and 547, respectively. In addition, interrupt generation circuits 535, 540, and 545 may generate output signals 130 (not shown in FIG. 5). In some embodiments, interrupt signals 537, 542, and 547 may be received by interrupt control circuit 550, e.g., a nested vectored interrupt controller. Interrupt control circuit 550 may prioritize the received interrupt signals and output interrupt signal 551 to interrupt servicing circuit 105. Based on interrupt signal 551, interrupt servicing circuit 105 may perform one or more interrupt service routine operations corresponding to interrupt generation circuits 535, 540, and 545. In some embodiments, after interrupt servicing circuit 105 performs the interrupt service routine operations, interrupt servicing circuit 105 may output mode indication signal 106 indicating a standby mode. Power control circuit 110 may receive the mode indication signal 106 and control clock generation circuit 115 and PMU 117 via clock control signal 112 and power control signal 113, respectively, to cause interrupt servicing circuit 105 to exit the active mode and re-enter the standby mode indicated by mode indication signal 106.

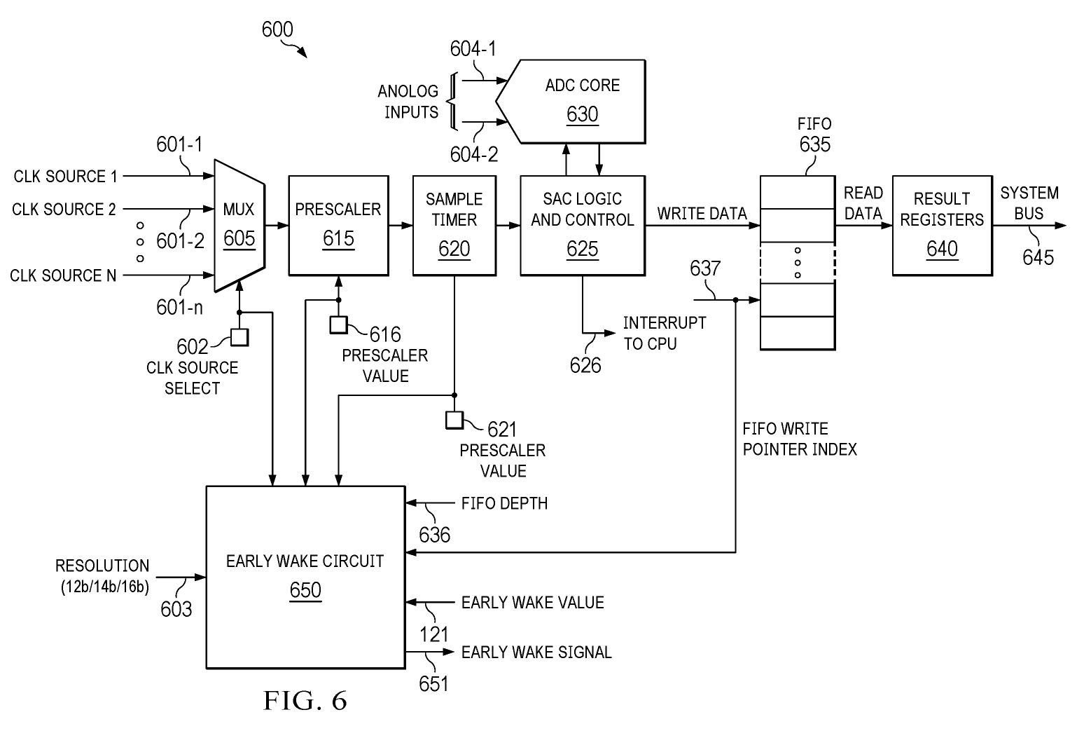

FIG. 6 illustrates an example interrupt generation circuit in an implementation. FIG. 6 includes interrupt generation circuit 600, which includes multiplexer 605, pre-scaler 615, sample timer 620, successive-approximation register (SAR) circuitry 625, analog-to-digital converter (ADC) circuitry 630, buffer memory 635, result registers 640, and early wake circuitry 650.

In various embodiments, interrupt generation circuit 600 may be representative of an interrupt generation circuit of a processing system, such as one of interrupt generation circuit(s) 125 of system 100 and/or interrupt generation circuits 535, 540, and/or 545 of system 500. More specifically, interrupt generation circuit 600 may be representative of an analog-to-digital converter circuit of a system.

In operation, multiplexer 605 of interrupt generation circuit 600 may be configured to receive a number of clock signals, such as clock signals 601-1, 601-2, and 601-n (collectively clock signals 601), and a clock selection signal 602. Clock selection signal 602 may indicate a clock signal of clock signals 601, and based on clock selection signal 602, multiplexer 605 may be configured to output a selected clock signal to pre-scaler 615.

Pre-scaler 615 may be configured to scale, multiply, divide, or the like the selected clock signal based on pre-scaler value 616 and output a scaled clock signal to sample timer 620. Sample timer 620 may be configured to generate a timer output signal based on the scaled clock signal and based on sample timer value 621. Sample timer 620 may output the timer output signal to SAR circuitry 625.

SAR circuitry 625 and ADC circuitry 630 may be representative of conversion circuitry of interrupt generation circuit 600 configured to convert input data (e.g., analog inputs 604-1 and 604-2) to digital output data to buffer memory 635 at a resolution 603 (e.g., 12-bit resolution, 14-bit resolution, 16-bit resolution), and in some embodiments, further, to downstream systems or devices. Specifically, ADC circuitry 630 may be configured to receive analog inputs 604-1 and 604-2 (e.g., from a sensor internal to or external to a processing system (e.g., system 100)) and convert the analog inputs based on the timer output signal received by SAR circuitry 625. SAR circuitry 625 may perform further conversion operations and write digital output data based on the conversion operations to buffer memory 635.

Buffer memory 635 may be representative of a storage medium capable of storing data output by SAR circuitry 625. As SAR circuitry 625 converts data to be written to buffer memory 635, SAR circuitry 625 may identify write pointer index 637 of buffer memory 635 indicative of a current write location of buffer memory 635 and write output data to buffer memory 635 at a location based on write pointer index 637. Buffer memory 635 may include a size or depth as defined by buffer size 636. Buffer memory 635 may be coupled to result registers 640, and output data 645 may be read from result registers 640 via a processor (e.g., interrupt servicing circuit 105) via a system bus.

Early wake circuitry 650 may also be included in interrupt generation circuit 600 to generate early wake signal 651 and enable early wake processes as described herein to transition an interrupt servicing circuit (e.g., interrupt servicing circuit 105) from a standby mode to an active mode before interrupt generation circuit 600 outputs interrupt signal 626. Early wake circuitry 650 may be configured to receive various inputs and parameters of elements of interrupt generation circuit 600, such as clock selection signal 602, pre-scaler value 616, sample timer value 621, buffer size 636, write pointer index 637, early wake value 121 from standby mode control circuit 120, and conversion resolution 603.

For example, in various embodiments, early wake circuitry 650 may be configured to generate early wake signal 651 based on early wake value 121 and based on determining a reference point and determining a lead time relative to the reference point. In some such embodiments, early wake circuitry 650 may determine the reference point based on one or more of the aforementioned inputs and parameters, such as write pointer index 637 and buffer size 636. In this way, early wake circuitry 650 may determine a remaining capacity of buffer memory 635. Early wake circuitry 650 may determine a lead time based further on the selected clock signal (e.g., based on clock selection signal 602, and the clock frequency thereof) to determine how quickly SAR circuitry 625 may fill the remaining capacity of buffer memory 635 to full occupancy. In some such embodiments, based on early wake value 121 indicating a value corresponding to a standby fast mode (e.g., 10 µs), early wake circuitry 650 may generate and output early wake signal 651 at a first time. In some such embodiments, based on early wake value 121 indicating a value corresponding to a standby slow mode (e.g., 100 µs), early wake circuitry 650 may generate and output early wake signal 651 at a second time earlier than the first time as early wake circuitry 650 may determine a lead time having a higher value than the lead time corresponding to the standby fast mode.

In some embodiments, additional or other parameters may be used to determine early wake signal 651 based on early wake value 121. In this way, early wake circuitry 650 may dynamically and adaptively determine when to output early wake signal 651 based on ongoing operational parameters of interrupt generation circuit 600 and based on early wake signal 121 corresponding to a particular type of standby mode.

Subsequent to generating early wake signal 651, SAR circuitry 625 may determine that buffer memory 635 has reached capacity and may output interrupt signal 626 to interrupt servicing circuit 105.

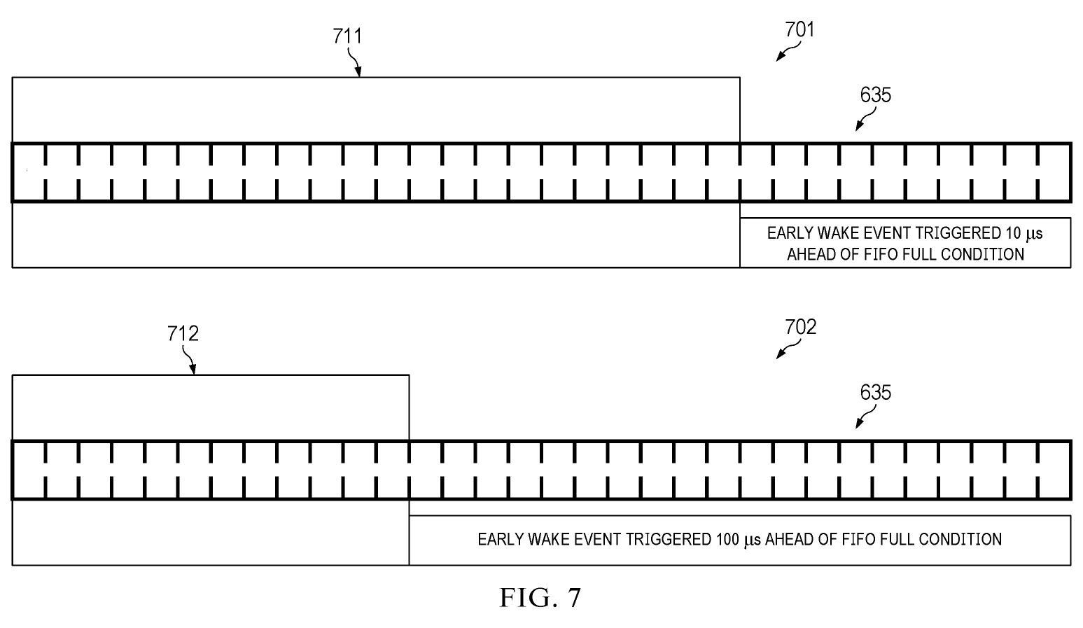

FIG. 7 illustrates an example aspect of an interrupt generation circuit in accordance with an implementation. FIG. 7 shows aspects 701 and 702, which include aspects of buffer memory 635 of interrupt generation circuit 600 and reference elements of FIGS. 1 and 6.

Referring first to aspect 701, aspect 701 shows buffer memory 635, which may include 32 memory locations. In aspect 701, early wake circuitry 650 may receive early wake value 121 corresponding to the standby fast mode (e.g., 10 µs). Based on early wake value 121 including a value corresponding to the standby fast mode, early wake circuitry 650 may determine buffer window 711 based on various parameters of interrupt generation circuit 600, such as the clock frequency of the selected clock signal of clock signals 601, pre-scaler value 616, sample timer value 621, and resolution 603, among other parameters.

In various embodiments, buffer window 711 may include a variable, sliding window based on a throughput of interrupt generation circuit 600 (e.g., a throughput of SAR circuitry 625 and ADC circuitry 630) and based on early wake value 121. More specifically, in some such embodiments, buffer window 711 may include a number of memory locations corresponding to a percentage of buffer size 637 of buffer memory 635. In operation, SAR circuitry 625 and ADC circuitry 630 may fill the memory locations of buffer memory 635 in an amount of time determinable based on the aforementioned parameters. As such, based on SAR circuitry 625 and ADC circuitry 630 filling the memory locations and reaching a target capacity corresponding to buffer window 711, early wake circuitry 650 may generate and output early wake signal 651 to provide power management circuitry (e.g., clock generation circuitry 115 and PMU 117) an amount of time, e.g., 10 µs corresponding to the standby fast mode, during which the power management circuitry can generate respective output signals and cause interrupt servicing circuit 105 to exit the standby fast mode and enter the active mode. During this duration, SAR circuitry 625 and ADC circuitry 630 may fill the remaining memory locations of buffer memory 635 with data and output interrupt signal 626 based on reaching the full capacity of buffer memory 635. The amount of time between the time early wake circuitry 650 outputs early wake signal 651 and the SAR circuitry 625 outputs interrupt signal 626 may be referred to as a lead time.

By way of example, in aspect 701, buffer window 711 may include buffer locations 1 to 22 based on an early wake value 121 including a time of 10 µs, the clock frequency including a frequency of 40 MHz, pre-scaler value 616 including a value of 2, sample timer value including a value of 4, and resolution 603 indicating that interrupt generation circuit 600 includes a 16-bit ADC. Based on these parameters, early wake circuitry 650 may determine that upon SAR circuitry 625 writing data to memory locations 1 through 22, early wake circuitry 650 may output early wake signal 651 to provide the power management circuitry sufficient time (e.g., 10 µs) to wake-up and cause interrupt servicing circuit 105 to exit the standby fast mode. During this time (e.g., 10 µs), SAR circuitry 625 and ADC circuitry 630 may fill remaining memory locations 22 to 32 and then generate interrupt signal 626 and output data 645.

Referring next to aspect 702, aspect 702 shows buffer memory 635, which may include 32 memory locations. In aspect 702, early wake circuitry 650 may receive early wake value 121 corresponding to the standby slow mode (e.g., 100 µs). Based on early wake value 121 including a value corresponding to the standby slow mode, early wake circuitry 650 may determine buffer window 712 based on various parameters of interrupt generation circuit 600, such as the clock frequency of the selected clock signal of clock signals 601, pre-scaler value 616, sample timer value 621, and resolution 603, among other parameters.

In aspect 702, buffer window 712 may include buffer locations 1 to 12 based on an early wake value 121 including a time of 100 µs, the clock frequency including a frequency of 8 MHz, pre-scaler value 616 including a value of 2, sample timer value including a value of 4, and resolution 603 indicating that interrupt generation circuit 600 includes a 16-bit ADC. Based on these parameters, early wake circuitry 650 may determine that upon SAR circuitry 625 writing data to memory locations 1 through 12, early wake circuitry 650 may output early wake signal 651 to provide the power management circuitry sufficient time (e.g., 100 µs) to wake-up and cause interrupt servicing circuit 105 to exit the standby fast mode. In this example, early wake circuitry 650 may output early wake signal 651 at an earlier time than in aspect 701 as the power management circuitry may require additional time to initialize additional clock signals and/or power supplies. Similarly, during this time (e.g., 100 µs), SAR circuitry 625 and ADC circuitry 630 may fill remaining memory locations 13 to 32 and then generate interrupt signal 626 and output data 645.

In some embodiments, other sizes of buffer memory 635, buffer windows, as well as other early wake values and parameters of interrupt generation circuit 600 may be contemplated.

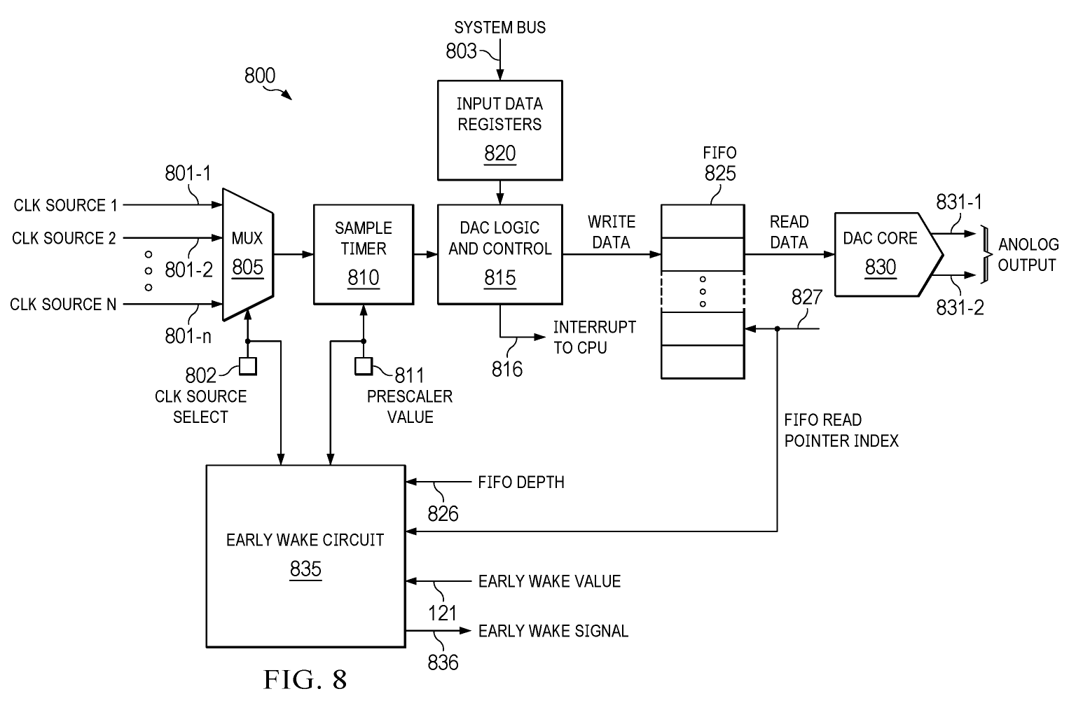

FIG. 8 illustrates an example interrupt generation circuit in an implementation. FIG. 8 includes interrupt generation circuit 800, which includes multiplexer 805, sample timer 810, digital-to-analog converter (DAC) logic circuitry 815, input data registers 820, buffer memory 825, DAC conversion circuitry 830, and early wake circuitry 835.

In various embodiments, interrupt generation circuit 800 may be representative of an interrupt generation circuit of a processing system, such as one of interrupt generation circuit(s) 125 of system 100 and/or interrupt generation circuits 535, 540, and/or 545 of system 500. More specifically, interrupt generation circuit 800 may be representative of a digital-to-analog converter circuit of a system.

In operation, multiplexer 805 of interrupt generation circuit 800 may be configured to receive a number of clock signals, such as clock signals 801-1, 801-2, and 801-n (collectively clock signals 801), and a clock selection signal 802. Clock selection signal 802 may indicate a clock signal of clock signals 801, and based on clock selection signal 802, multiplexer 805 may be configured to output a selected clock signal to sample timer 810.

Sample timer 810 may be configured to generate a timer output signal based on the selected clock signal and based on sample timer value 811. Sample timer 810 may output the timer output signal to DAC logic circuitry 815.

DAC logic circuitry 815 may be representative of conversion circuitry of interrupt generation circuit 800 configured to write digital data from input data registers 820 based on digital input signals 803 to buffer memory 825. DAC conversion circuitry 830 may be representative of conversion circuitry of interrupt generation circuit 800 configured to read the digital data from buffer memory 825, convert the digital data to analog output signals 831-1 and 831-2, and output analog output signals 831-1 and 831-2 to one or more downstream systems and/or devices (e.g., a sensor, a processing device).

Buffer memory 825 may be representative of a storage medium capable of storing data output by DAC logic circuitry 815. As DAC logic circuitry 815 writes data to buffer memory 825, DAC conversion circuitry 830 may identify read pointer index 827 of buffer memory 825 indicative of a current read location of buffer memory 825 and read data from buffer memory 825 at a location based on read pointer index 827. Buffer memory 825 may include a size or depth as defined by buffer size 826.

Early wake circuitry 835 may also be included in interrupt generation circuit 800 to generate early wake signal 836 and enable early wake processes as described herein to transition an interrupt servicing circuit (e.g., interrupt servicing circuit 105) from a standby mode to an active mode before interrupt generation circuit 800 outputs interrupt signal 816. Early wake circuitry 835 may be configured to receive various inputs and parameters of elements of interrupt generation circuit 800, such as clock selection signal 602, sample timer value 811, buffer size 826, write pointer index 827, and early wake value 121 from standby mode control circuit 120.

For example, in various embodiments, early wake circuitry 835 may be configured to generate early wake signal 836 based on early wake value 121 and based on determining a lead time and determining a reference point relative to the lead time. In some such embodiments, early wake circuitry 835 may determine the reference point based on one or more of the aforementioned inputs and parameters, such as write pointer index 827 and buffer size 826. In this way, early wake circuitry 835 may determine a remaining capacity of buffer memory 825. Early wake circuitry 835 may determine a lead time based further on the selected clock signal (e.g., based on clock selection signal 802, and the clock frequency thereof) to determine how quickly DAC logic circuitry 815 may fill buffer memory 825 to capacity and/or how quickly DAC conversion circuitry 830 may empty buffer memory 825. In some such embodiments, based on early wake value 121 indicating a value corresponding to a standby fast mode, early wake circuitry 835 may generate and output early wake signal 836 at a first time. In some such embodiments, based on early wake value 121 indicating a value corresponding to a standby slow mode, early wake circuitry 835 may generate and output early wake signal 836 at a second time earlier than the first time as early wake circuitry 835 may determine a lead time having a higher value than the lead time corresponding to the standby fast mode.

In some embodiments, additional or other parameters may be used to determine early wake signal 836 based on early wake value 121. In this way, early wake circuitry 835 may dynamically and adaptively determine when to output early wake signal 836 based on ongoing operational parameters of interrupt generation circuit 800 and based on early wake signal 121 corresponding to a particular type of standby mode.

Subsequent to generating early wake signal 836, DAC logic circuitry 815 may determine that buffer memory 825 has reached capacity and may output interrupt signal 816 to interrupt servicing circuit 105.

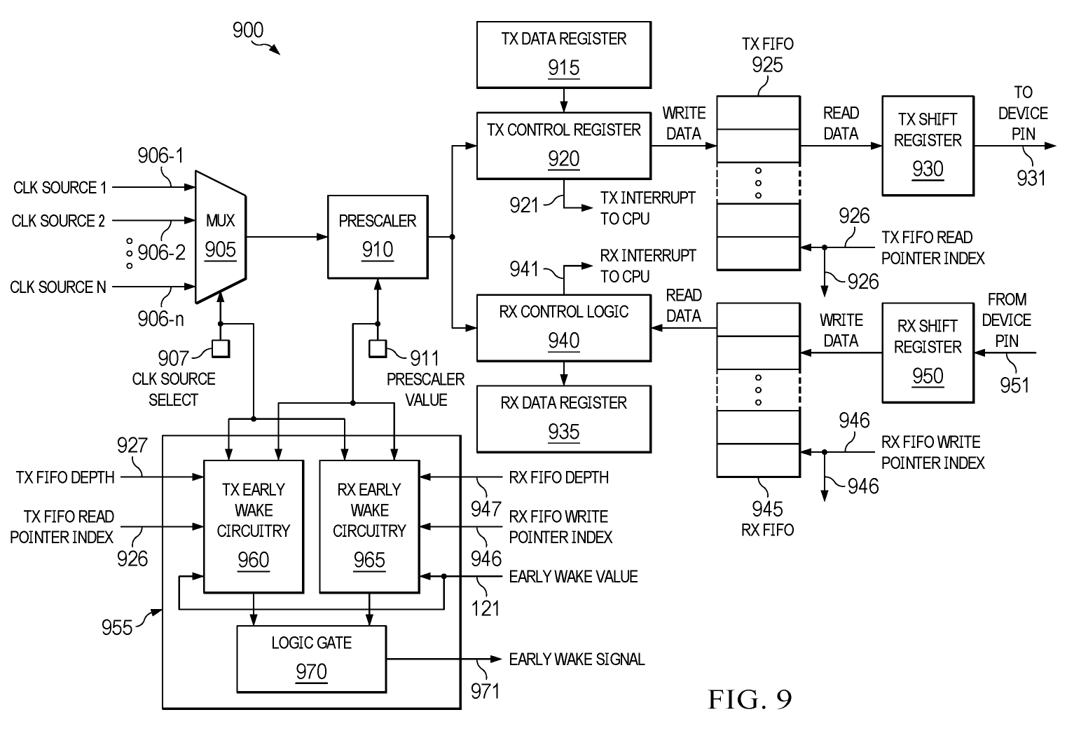

FIG. 9 illustrates an example interrupt generation circuit in an implementation. FIG. 9 includes interrupt generation circuit 900, which includes multiplexer 905, pre-scaler 910, transmitter data register 915, transmitter control logic 920, buffer memory 925, transmitter shift register 930, receiver control logic 940, receiver data register 935, buffer memory 945, receiver shift register 950, and early wake circuitry 955. Early wake circuitry 955 further includes transmitter early wake circuitry 960, receiver early wake circuitry 965, and logic gate 970. In various embodiments, interrupt generation circuit 900 may be representative of an interrupt generation circuit of a processing system, such as one of interrupt generation circuit(s) 125 of system 100 and/or interrupt generation circuits 535, 540, and/or 545 of system 500.

In various embodiments, interrupt generation circuit 900 may be representative of an interrupt generation circuit of a processing system, such as one of interrupt generation circuit(s) 125 of system 100 and/or interrupt generation circuits 535, 540, and/or 545 of system 500. More specifically, interrupt generation circuit 900 may be representative of a serial communication circuit of a system, such as a transmitter, a receiver, and/or a transceiver.

In operation, multiplexer 905 of interrupt generation circuit 900 may be configured to receive a number of clock signals, such as clock signals 901-1, 901-2, and 901-n (collectively clock signals 901), and a clock selection signal 902. Clock selection signal 902 may indicate a clock signal of clock signals 901, and based on clock selection signal 902, multiplexer 905 may be configured to output a selected clock signal to pre-scaler 910.

Pre-scaler 910 may be configured to scale, multiply, divide, or the like the selected clock signal based on pre-scaler value 911 and output a scaled clock signal to transmitter control logic 920 and receiver control logic 940.

Transmitter control logic 920 may be representative of circuitry configured to write communication data to buffer memory 925 based on communication data located in one or more registers of transmitter data register 915. Similarly, receiver control logic 940 may be representative of circuitry configured to write received communication data to buffer memory 945 based on received communication data located in one or more registers of receiver data register 935.

Buffer memories 925 and 945 may be representative of storage media capable of storing data output by transmitter control logic 920 and receiver control logic 935, respectively. As respective elements write data to buffer memories 925 and 945, data may be read from buffer memories 925 and 945 and stored in one or more locations of transmitter shift register 930 and receiver shift register 950, respectively. Transmitter shift register 930 may read data of buffer memory 925 based on read pointer index 926, and receiver shift register 950 may read data of buffer memory 945 based on read pointer index 946. Buffer memory 925 may include a size or depth as defined by buffer size 927, and buffer memory 945 may include a size or depth as defined by buffer size 947.

Early wake circuitry 955 may also be included in interrupt generation circuit 900 to generate early wake signal 971 and enable early wake processes as described herein to transition an interrupt servicing circuit (e.g., interrupt servicing circuit 105) from a standby mode to an active mode before interrupt generation circuit 900 outputs interrupt signal 921 and/or interrupt signal 941. Early wake circuitry 955 may be configured to receive various inputs and parameters of elements of interrupt generation circuit 900, such as clock selection signal 907, pre-scaler value 911, buffer size 927, buffer size 947, read pointer index 926, read pointer index 946, and early wake value 121 from standby mode control circuit 120. Early wake circuitry 955 may include transmitter early wake circuitry 960, which may be configured to generate and output an early wake signal based on transmitter-related circuitry of interrupt generation circuit 900 (e.g., transmitter control logic 920, buffer memory 925, transmitter shift register 930), and receiver early wake circuitry 965, which may be configured to generate and output an early wake signal based on receiver-related circuitry of interrupt generation circuit 900 (e.g., receiver control logic 940, buffer memory 945, receiver shift register 950).

For example, in various embodiments, early wake circuitry 955 may be configured to generate early wake signal 971 based on an early wake signal output by one or more of transmitter early wake circuitry 960 and receiver early wake logic 965. Transmitter early wake circuitry 960 and receiver early wake logic 965 may generate and output a respective early wake signal based on early wake value 121 and based on determining a respective lead time and determining a reference point relative to the lead time. In some such embodiments, transmitter early wake circuitry 960 and receiver early wake circuitry 965 may determine respective reference points based on one or more of the aforementioned inputs and parameters, such as respective read pointer indexes, buffer sizes, and the like.

For example, transmitter early wake circuitry 960 may determine a remaining capacity of buffer memory 925. Transmitter early wake circuitry 960 may determine a lead time based further on the selected clock signal (e.g., based on clock selection signal 907, and the clock frequency thereof) to determine how quickly transmitter control logic 920 may fill buffer memory 925 to capacity and/or how quickly transmitter shift register 930 may empty buffer memory 925. In some such embodiments, based on early wake value 121 indicating a value corresponding to a standby fast mode, transmitter early wake circuitry 960 may generate and output an early wake signal at a first time to logic gate 970. In some such embodiments, based on early wake value 121 indicating a value corresponding to a standby slow mode, transmitter early wake circuitry 960 may generate and output the early wake signal at a second time earlier than the first time as transmitter early wake circuitry 960 may determine a lead time having a higher value than the lead time corresponding to the standby fast mode.

With respect to receiver early wake circuitry 965, receiver early wake circuitry 965 may determine a remaining capacity of buffer memory 945. Receiver early wake circuitry 965 may determine a lead time based further on the selected clock signal (e.g., based on clock selection signal 907, and the clock frequency thereof) to determine how quickly receiver control logic 940 may fill buffer memory 945 to capacity and/or how quickly receiver shift register 950 may empty buffer memory 945. In some such embodiments, based on early wake value 121 indicating a value corresponding to a standby fast mode, receiver early wake circuitry 965 may generate and output an early wake signal at a first time to logic gate 970. In some such embodiments, based on early wake value 121 indicating a value corresponding to a standby slow mode, receiver early wake circuitry 965 may generate and output the early wake signal at a second time earlier than the first time as receiver early wake circuitry 965 may determine a lead time having a higher value than the lead time corresponding to the standby fast mode.

Logic gate 970 may be representative of a digital logic gate (e.g., an OR gate) that may be configured to receive the early wake signals and based on one or more of the early wake circuits outputting an early wake signal, logic gate 970 may output early wake signal 971.

In some embodiments, additional or other parameters may be used to determine early wake signal 971 based on early wake value 121. In this way, early wake circuitry 955 may dynamically and adaptively determine when to output early wake signal 971 based on ongoing operational parameters of interrupt generation circuit 900 and based on early wake signal 121 corresponding to a particular type of standby mode.

Subsequent to generating early wake signal 971, transmitter control logic 920 and/or receiver control logic 940 may determine that buffer memory 925 and/or buffer memory 945, respectively, has reached capacity and may output interrupt signal 921 and/or interrupt signal 941, respectively, to interrupt servicing circuit 105.

While some examples provided herein are described in the context of a processing system, interrupt generation and servicing system, control circuitry, early wake circuitry, peripheral circuitry, power management circuitry, clock generation circuitry, an embedded system or system-on-chip, sub-circuit, system, subsystem, component, device, architecture, or environment, it should be understood that the elements, components, systems, and methods described herein are not limited to such embodiments and may apply to a variety of other processes, systems, applications, devices, and the like, such as other circuits, logic devices, transistors, and the like, in the context of wake-up and system initialization functionality, for example. Accordingly, aspects of the present invention may be embodied as other systems, methods, and other configurable systems.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The phrases "in some embodiments," "according to some embodiments," "in the embodiments shown," "in other embodiments," and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for” but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A system, comprising:
a standby mode control circuit configured to:
receive an indication of a standby mode; and
determine an early wake value based on the standby mode; and
a first interrupt generation circuit coupled to the standby mode control circuit, wherein the first interrupt generation circuit is configured to:
receive the early wake value;
determine a first lead time value based on the early wake value;
generate a first early wake signal corresponding to the standby mode based on the first lead time value; and
subsequent to generating the first early wake signal, generate an interrupt signal.

2. The system of claim 1, further comprising an interrupt servicing circuit configured to:
exit the standby mode based on the first early wake signal; and
subsequent to exiting the standby mode,
receive the interrupt signal; and
perform an interrupt service operation based on the interrupt signal.

3. The system of claim 2, further comprising a power control circuit, wherein:
the standby mode control circuit is further configured to generate a wake mode signal based on receiving the first early wake signal; and
the power control circuit is configured to cause the interrupt servicing circuit to exit the standby mode based on the wake mode signal.

4. The system of claim 3, further comprising:
a clock generation circuit configured to generate a clock signal; and
a power management unit configured to generate a voltage,
wherein the power control circuit is configured to control the clock generation circuit, the power management unit, or a combination thereof, to cause the interrupt servicing circuit to exit the standby mode.

5. The system of claim 2, wherein:
the standby mode is a first mode or a second mode;
the first mode corresponds to a first duration for the interrupt servicing circuit to exit the standby mode;
the second mode corresponds to a second duration for the interrupt servicing circuit to exit the standby mode; and
the early wake value comprises a first value based on the standby mode being the first mode or a second value based on the standby mode being the second mode.

6. The system of claim 1, further comprising a second interrupt generation circuit configured to:
receive the early wake value;
determine a second lead time value based on the early wake value;
generate a second early wake signal corresponding to the standby mode based on the second lead time value; and
subsequent to generating the second early wake signal, generate a second interrupt signal.

7. The system of claim 6, wherein the second lead time value is different from the first lead time value.

8. The system of claim 1, wherein to determine the first lead time value, the first interrupt generation circuit is configured to:
determine a reference point;
determine a duration based on a clock frequency of the first interrupt generation circuit; and
determine the first lead time value relative to the reference point based on the duration.

9. The system of claim 8, wherein:
the first interrupt generation circuit comprises a buffer memory; and
the first interrupt generation circuit is configured to determine the reference point based on full occupancy of the buffer memory.

10. The system of claim 1, wherein the first interrupt generation circuit comprises one of an analog-to-digital converter, a digital-to-analog converter, or a communication circuit.

11. A device, comprising:
a power control circuit configured to:
receive an indication of a standby mode; and
control power management circuitry based on the standby mode; and
a mode control circuit coupled to the power control circuit and configured to:
determine an early wake value based on the standby mode;
output the early wake value;
in response to outputting the early wake value, receive an early wake signal corresponding to the standby mode based on the early wake value; and
control the power control circuit based on the early wake signal.

12. The device of claim 11, further comprising:
a first interrupt generation circuit coupled to the mode control circuit and configured to:
receive the early wake value;
determine a first lead time value based on the early wake value;
generate the early wake signal corresponding to the standby mode based on the first lead time value; and
subsequent to generating the early wake signal, output an interrupt signal.

13. The device of claim 12, further comprising an interrupt servicing circuit configured to:
exit the standby mode based on the early wake signal; and
subsequent to exiting the standby mode,
receive the interrupt signal; and
perform an interrupt service operation based on the interrupt signal.

14. The device of claim 13, wherein:
the standby mode is a first mode or a second mode;
the first mode corresponds to a first duration for the interrupt servicing circuit to exit the standby mode;
the second mode corresponds to a second duration for the interrupt servicing circuit to exit the standby mode; and
the early wake value comprises a first value based on the standby mode being the first mode or a second value based on the standby mode being the second mode.

15. The device of claim 12, wherein to determine the first lead time value, the first interrupt generation circuit is configured to:
determine a reference point;
determine a duration based on a clock frequency of the first interrupt generation circuit; and
determine the first lead time value relative to the reference point based on the duration.

16. The device of claim 15, wherein:
the first interrupt generation circuit comprises a buffer memory; and
the first interrupt generation circuit is configured to determine the reference point based on full occupancy of the buffer memory.

17. A system, comprising:
a first circuit configured to:
receive an early wake value corresponding to a standby mode;
determine a lead time value based on the early wake value; and
generate an early wake signal corresponding to the standby mode based on the lead time value; and
a second circuit coupled to the first circuit and configured to:
subsequent to the first circuit generating the early wake signal, generate an interrupt signal.

18. The system of claim 17, further comprising a standby mode control circuit coupled to the first circuit and configured to:
in response to receiving the early wake signal from the first circuit, generate a wake mode signal based on the early wake signal.

19. The system of claim 18, further comprising an interrupt servicing circuit configured to:
exit the standby mode based on the wake mode signal; and
subsequent to exiting the standby mode,
receive the interrupt signal; and
perform an interrupt service operation based on the interrupt signal.

20. The system of claim 17, wherein the system further comprises a memory, and wherein to determine the lead time value based on the early wake value, the first circuit is configured to:
determine a reference point; and
determine the reference point based on full occupancy of the memory.
